(19) United States
(12) Patent Application Publication
(10) Pub. No.: US 2012/0168415 A1
(43) Pub. Date: Jul. 5, 2012

(54) Butt-welding and electrofusion joining machine

(76) Inventors: Kwai Yin Tsang, Hong Kong (CN); Tak Ming Chick, Hong kong (CN)

(21) Appl. No.: 13/063,756

(22) PCT Filed: Jul. 12, 2010
(86) PCT No.: PCT/CN2010/075110

§ 371 Date: Mar. 13, 2011

(30) Foreign Application Priority Data
Sep. 27, 2009 (CN) 200920205476.3

(51) Int. Cl. B23K 11/00

(52) U.S. Cl. 219/148

(57) ABSTRACT

A butt-welding and electro-fusion joining machine comprises a smoothing board, a heating board, fixed rings, a movable ring, throat pipe moulds, a manual switch, cross beams, and uprights, wherein the fixed rings and movable ring are set in turn on the cross beams of the uprights; the throat pipe moulds are set inside the fixed ring and the movable ring; the heating board is set at one end of the uprights; at one side of the heating board is fixed rings, and the other side is the smoothing board; the manual switch is set on the cross beams; the length of the cross beams is sufficient for placing pipes and fittings; the movable ring is set between the fixed rings and moves back and forth along the cross beams according to the length of the pipes and fittings joined by electro fusion.

### BACKGROUND

1. Field of the Invention

The present invention is related to a butt-welding and electrofusion joining machine, specifically to the joining machine which is capable of butt-welding pipes, such as PE and PPR, and securing the interface areas that are joined through the electrofusion.

2. Brief Description of Related Arts

Butt-welding is one of the methods of joining PE and PPR pipes used in the water supply and drainage system. The conventional way is to clamp the pipes and fittings on the hot-melt welding machine, with two end faces being aligned with each other; mill the two end faces with the milling cutter until getting flattened; heat the ends of pipes by using the hot-melt welding machine; when the ends of the pipes are melt, laminate them together quickly in order to keep a certain pressure; and then cool it down to achieve the goal of welding. The existing butt-welding machine only has a single function of butt-welding. To mill or smooth the interface area of the electric-melt pipes or fittings and secure the electric-melt interface ready to be cooled down, an extra machine or tool is still needed.

### SUMMARY OF THE INVENTION

The object of the present invention is to furnish a butt-welding and electrofusion joining machine, which has changed the structure of the conventional butt fusion welding machine, can smooth the interface area of the pipes and fittings joined by electrofusion, and fasten the interface area that is ready to be cooled down.

The present invention has two main technical projects.

Project One:

The butt-welding and electrofusion joining machine comprises a smoothing board, a heating board, fixed rings, a movable ring, throat pipe moulds, a manual switch, cross beams, and uprights, wherein the fixed rings and movable ring are set in turn across the cross beams of the uprights; the throat pipe moulds are set inside the fixed ring and the movable ring; the heating board is set at one end of the uprights; at one side of the heating board are the fixed rings, and the other side is the smoothing board; the manual switch is set on the cross beams; the length of the cross beams is sufficient for placing electrofusion pipes and fittings; the movable ring is set between the fixed rings and moves back and forth along the cross beams according to the length of the electrofusion pipes and fittings joined by electro fusion.

The project described above further includes that the throat pipe moulds set inside the fixed rings and the movable ring are the split structure, each with different diameter, which are assembled and overlapping, one over the other in the sequence from big to small. The throat pipe moulds with different diameters are for pipes and fittings with corresponding different sizes.

Another Alternative Project is:

The butt-welding and electro-fusion joining machine comprises a smoothing board, a heating board, fixed rings, a movable ring, throat pipe moulds, cross beams, uprights, and a hydraulic press, wherein on the cross beams of the uprights are set the fixed rings and the movable ring; the throat pipe moulds are set inside the fixed rings and movable ring; the heating board is set at one end of the uprights; the one side of the heating board is the fixed rings, and the other side is the smoothing board; the hydraulic press is set at the other end of the uprights; the length of the cross beams is sufficient for electrofusion placing pipes and fittings joined by electrofusion; the movable ring is put between the fixed rings, and moves back and forth along the beams according to the length of the electrofusion pipes and fittings.

The project described above further includes that the throat pipe moulds inside the fixed rings and the movable ring are split structures, each with different diameter, which are assembled and overlapping, one over another in the sequence from big to small. The different throat pipe moulds correspond to the pipes and fittings with different sizes.

The structure of the project one comprises the smoothing board, the heating board, the fixed rings, the movable ring, the throat pipe moulds, the manual switch, the cross beams, and the uprights. The cross beams can be extended in order to place pipes and fittings which are going to be electric-melt. One of the fixed rings can be changed from being fixed on the cross beams to being capable of moving back and forth according to the length of the pipes and fittings. The distance between the movable ring and fixed rings is no less than 750 mm. Nine throat pipe moulds of different diameters are fixed through screws inside the fixed rings, including the diameters of 63 mm, 75 mm, 90 mm, 110 mm, 125 mm, 140 mm, 160 mm, 180 mm, 200 mm, which are overlapping one over another and detachable to match the throat pipes of different sizes.

The structure of the project one comprises the smoothing board, the heating board, the fixed rings, the movable ring, the throat pipe moulds, the hydraulic press, the cross beams, and the uprights. The cross beams can be extended in order to place pipes and fittings which are going to be joined. One of the fixed rings can be changed from being fixed on the cross beams to being capable of moving back and forth according to the length of the pipes and fittings. The distance between the movable ring and fixed rings is not less than 2100 mm. Nine throat pipe moulds of different diameters are fixed through screws inside the fixed rings, including the diameters of 225 mm, 250 mm, 315 mm, 355 mm, 400 mm, 450 mm, 500 mm, 560 mm, 630 mm, which are overlapping one over another and detachable to match the throat pipes of different sizes.

The present invention has the advantages of being durable, convenient-used, lower cost because of the simple structure, and can be applied to the pipes and fittings with different sizes and shapes.

### BRIEF DESCRIPTION OF DRAWINGS

FIG. 1 is the oblique view of the present invention, in which the joining is operated by hand;

FIG. 2 is the vertical view of FIG. 1;

FIG. 3 is the side view of FIG. 1;

FIG. 4 is the oblique view of another side of FIG. 1;

FIG. 5 is another oblique view of the present invention, in which the joining is operated through a hydraulic press;

FIG. 6 is the vertical view of FIG. 5;

FIG. 7 is the side view of FIG. 5;

FIG. 8 is the oblique view of another side of FIG. 5;

FIG. 9 illustrates the throat pipe moulds.

In the drawings, the reference numeral 1 represents the smoothing board, 2 represents the heating board, 3 represents fixed rings, 4 represents the movable ring, 5 represents throat pipe moulds, 6 represents the manual switch, 7 represents cross beams, 8 represents the uprights, 9 represents the hydraulic press.

### DETAILED DESCRIPTION OF THE PREFERRED EMBODIMENTS

In the following detailed description of the embodiments, reference is made to the accompanying drawings which form a part hereof, and in which are shown by way of illustration specific embodiments in which the disclosure may be practiced. These embodiments are disclosed in sufficient detail to enable those skilled in the art to practice the invention, and it is to be understood that other embodiments may be utilized and that structural, logical and electrical changes may be made without departing from the spirit and scope of the disclosure. The following descriptions are, therefore, not to be taken in a limiting sense, and the scope of the disclosure is defined only by the appended claims.

The present invention has two main structures. The first one comprises a smoothing board 1, a heating board 2, several fixed rings 3, a movable ring 4, throat pipe moulds 5, a manual switch 6, cross beams 7, and uprights 8, in which along the cross beams of the upright are set in turn a fixed ring 3, another fixed ring 3, a movable ring 4 and another fixed ring 3. The second comprises a smoothing board 1, a heating board 2, several fixed rings 3, a movable ring 4, throat pipe moulds 5, cross beams 7, uprights 8, and a hydraulic press 9, wherein along the cross beams of the uprights are set in turn a fixed ring 3, another fixed ring, a movable ring 4, and another fixed ring 3.

### Example I

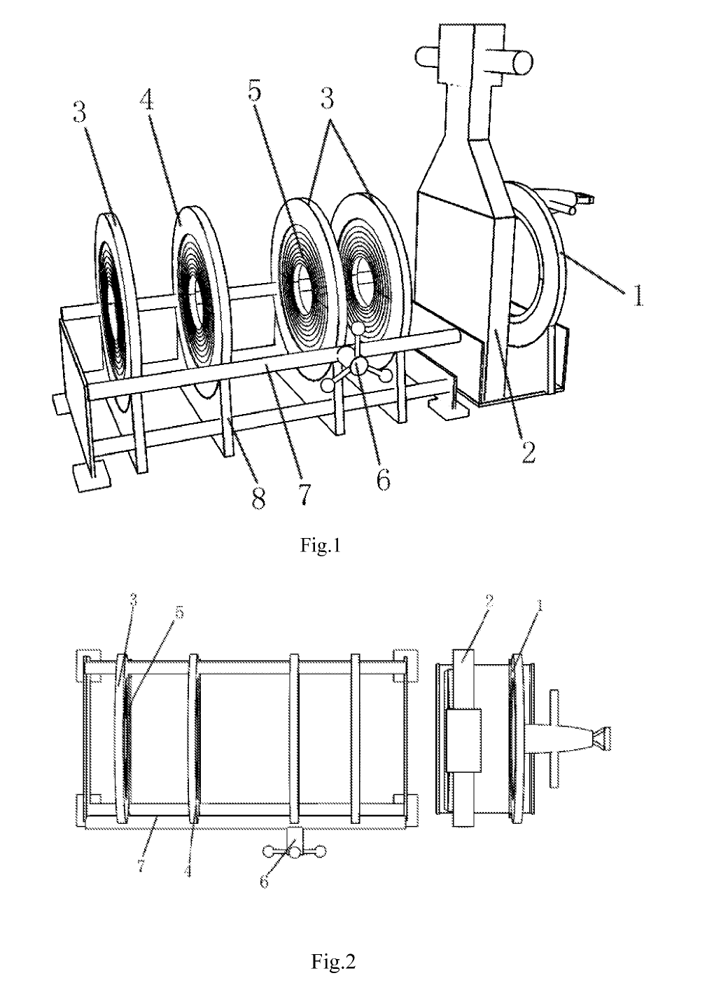

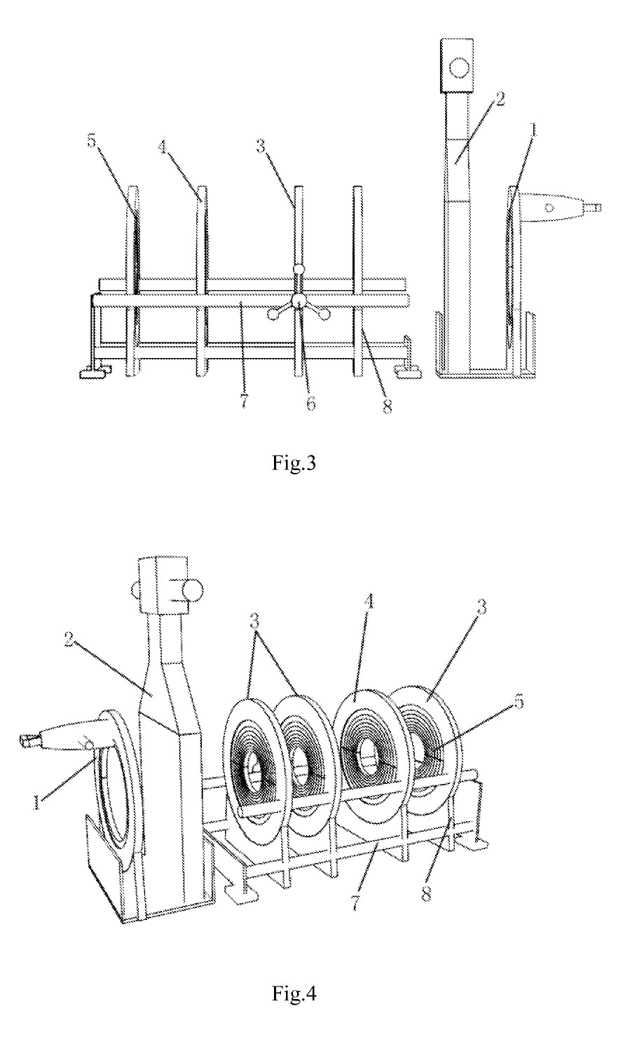

As shown in FIG. 1-FIG. 4, the joining machine of the present invention is operated by hand, and can be used for electrofusion welding. First, use the smoothing board 1 to smooth pipes and fittings so as to make the interface areas at their two ends be symmetrical, then turn the manual switch 6 to insert the pipes and fittings into the fixed rings 3, during which it should be noticed to adjust the position of the movable ring 4 according to the different length of the pipes. After gone through electro fusion welding, the pipes and fittings are fixed inside the fixed rings 3, thereby keeping up a certain pressure, so that preventing the throat pipes from deflection or flattening when heated and softened, and allowing them to be taken out when the interface area cools down completely. The throat pipe moulds 5 are detachable, so that they may match the pipes and fittings with different size.

### Example II

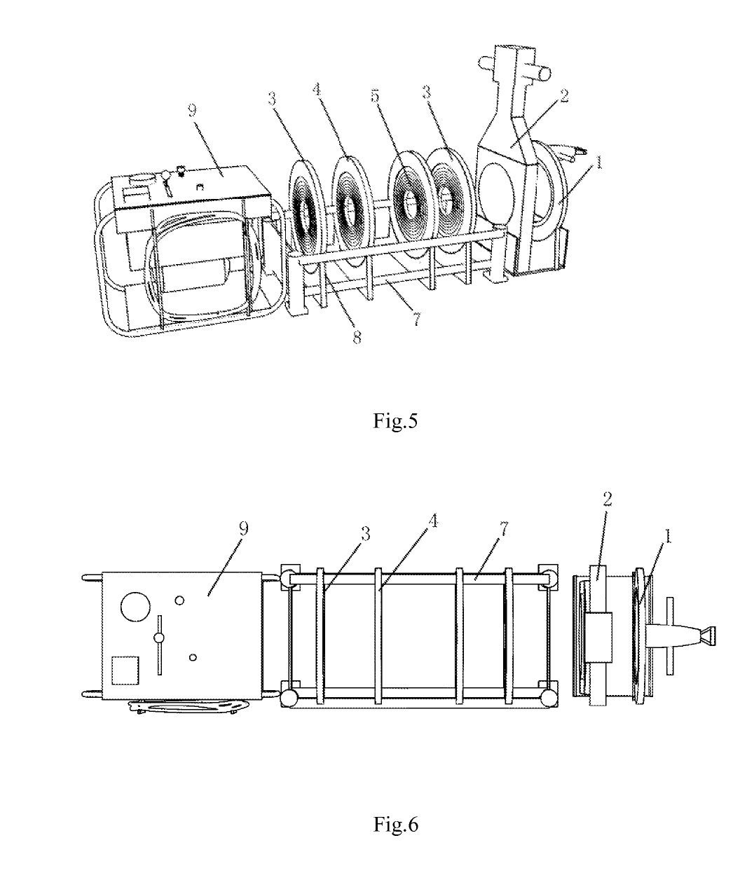

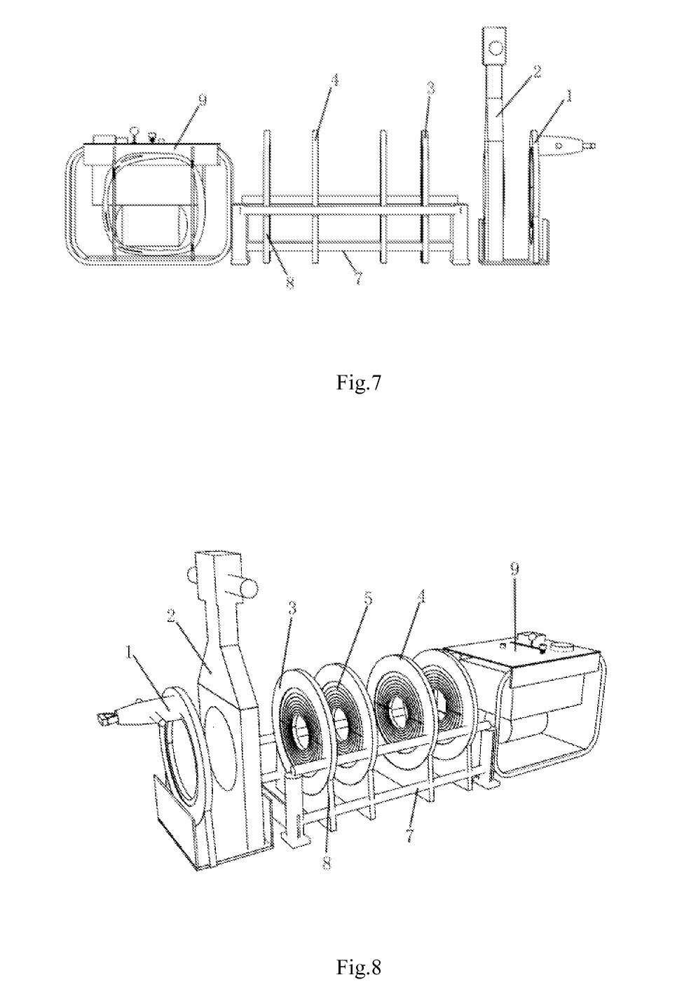

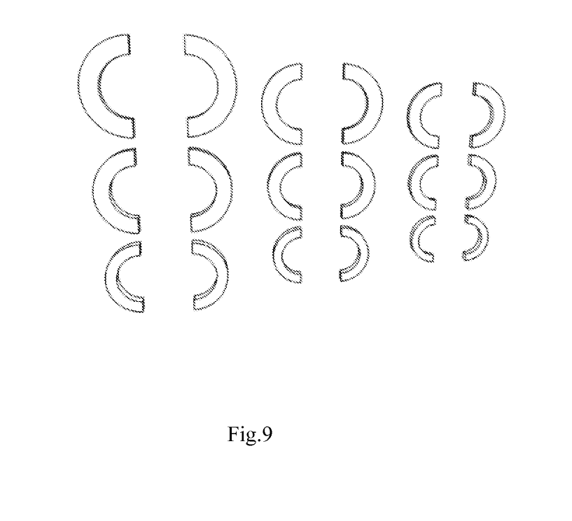

The embodiment is operated through a hydraulic press. As shown in FIG. 5-FIG. 8, the joining machines can be used for electrofusion. First, use the smoothing board 1 to smooth pipes and fittings so as to make the interface areas at their two ends be symmetrical, then turn on the hydraulic press, and insert the pipes and fittings into the fixed rings 3, during which it should be noticed to adjust the position of the movable ring 4 according to the different length of the pipes. After gone through electro fusion welding, the pipes and fittings are fixed inside the fixed rings 3, thereby keeping up a certain pressure, so that preventing the throat pipes from deflection or flattening when heated and softened, and allowing them to be taken out when the interface area cools down completely. The throat pipe moulds 5 detachable, so that they may match the pipes and fittings with different size.

What is claimed is:

1. A butt-welding electro-fusion joining machine, comprising
a smoothing board;
a heating board;
fixed rings;
a movable ring;
throat pipe moulds;
a manual switch;
cross beams; and
uprights,
wherein the fixed rings and movable ring are set in turn on the cross beams of the uprights; the throat pipe moulds are set inside the fixed ring and the movable ring;
the heating board is set at one end of the uprights;
at one side of the heating board is the fixed rings, and the other side is the smoothing board
the manual switch is set on the cross beams;
the length of the cross beams is sufficient for placing pipes and fittings;
the movable ring is set between the fixed rings and moves back and forth along the cross beams according to the length of the pipes and fittings joined by electro fusion.

2. The butt-welding electro-fusion joining machine recited in claim 1, wherein the throat pipe moulds set inside the fixed rings and movable ring are a split structure and with different diameter, which are assembled together and overlapping one over another in the sequence of from big to small, so as to match pipes and fittings with different size.

3. The butt-welding electro-fusion joining machine recited in claim 1, wherein the distance between the fixed rings and movable ring is no less than 750 mm.

4. The butt-welding electro-fusion joining machine recited in claim 2, wherein the throat pipe moulds with different diameter have the following sizes: 63 mm, 75 mm, 90 mm, 110 mm, 125 mm, 140 mm, 160 mm, 180 mm, 200 mm.

5. A butt-welding electro-fusion joining machine, comprising
a smoothing board;
a heating board;
fixed rings;
a movable ring;
throat pipe moulds;
a hydraulic press;
cross beams; and
uprights,
wherein the fixed rings and movable ring are set in turn on the cross beams of the uprights; the throat pipe moulds are set inside the fixed ring and the movable ring;
the heating board is set at one end of the uprights;
at one side of the heating board is the fixed rings, and the other side is the smoothing board
the hydraulic press is installed at the other end of the upright;
the length of the cross beams is sufficient for placing pipes and fittings;
the movable ring is set between the fixed rings and moves back and forth along the cross beams according to the length of the pipes and fittings joined by electro fusion.

6. The butt-welding electro-fusion joining machine recited in claim 5, wherein the throat pipe moulds set inside the fixed rings and movable ring are a split structure and with different diameter, which are assembled together and overlapping one over another in the sequence of from big to small, so as to match pipes and fittings with different size.

7. The butt-welding electro-fusion joining machine recited in claim 5, wherein the distance between the fixed rings and movable ring is no less than 2100 mm.

8. The butt-welding electro-fusion joining machine recited in claim 6, wherein the throat pipe moulds with different diameter have the following sizes: 225 mm, 250 mm, 315 mm, 355 mm, 400 mm, 450 mm, 500 mm, 560 mm, 630 mm.
